(19) United States
(12) Patent Application Publication
(10) Pub. No.: US 2025/0004812 A1
(43) Pub. Date: Jan. 2, 2025

(54) DISAGGREGATED MEMORY MANAGEMENT FOR VIRTUAL MACHINES

(71) Applicant: Western Digital Technologies, Inc., San Jose, CA (US)

(72) Inventors: Marjan Radi, San Jose, CA (US); Dejan Vucinic, San Jose, CA (US)

(21) Appl. No.: 18/232,780

(22) Filed: Aug. 10, 2023

Related U.S. Application Data
(60) Provisional application No. 63/523,601, filed on Jun. 27, 2023.

(51) Int. Cl. G06F 9/455

(52) U.S. Cl. CPC G06F 9/45558; G06F 2009/45583; G06F 2009/45595

(57) ABSTRACT

A server includes at least one local memory used as a portion of a shared memory. The server communicates with network devices that are each configured to provide a respective shared memory via a network. A Virtual Switching (VS) kernel module executed in a kernel space of the server receives a packet from a Virtual Machine (VM) executed by the at least one processor or by a processor of a remote server and parses the packet to identify a memory request from an application executed by the VM. Memory usage information is determined for the application based at least in part on the identified memory request. The memory usage information is provided to a VS controller of the server, which adjusts at least one of a memory request rate and a memory allocation for the application based at least in part on the determined memory usage information.

### CROSS-REFERENCE TO RELATED APPLICATION

This application claims the benefit of U.S. Provisional Application No. 63/523,601 titled “DISAGGREGATED MEMORY MANAGEMENT FOR VIRTUAL MACHINES” (Atty. Docket No. WDA-6998P-US), filed on Jun. 27, 2023, which is hereby incorporated by reference in its entirety.

### BACKGROUND

Current trends in cloud computing, big data, machine learning, and Input/Output (I/O) intensive applications have led to greater needs for large-scale, shared memory systems. In addition, the proliferation of varying computing applications in data centers, such as with cloud computing, has led to greater diversity in memory requirements among the different applications in large-scale, shared memory systems. This can result in some of the system's servers having excess memory, while other servers have insufficient memory for the applications using its memory. Conventional memory interfaces typically do not perform active memory allocation for changing workloads and the memory allocations are typically limited by the number of active memory controllers and Central Processing Units (CPUs).

Memory disaggregation is currently being used in distributed computational environments to support more efficient resource management and low-latency memory access. Existing solutions are generally based on Remote Direct Memory Access (RDMA) technology to enable an end-node to have access to remote memory. However, memory disaggregation using RDMA typically involves a large software overhead due to large data copies, while maximum memory capacity is still limited by the number of CPUs.

Pooling the memory resources of networked devices with memory disaggregation has additional challenges, such as managing the memory pool and the memory access of different nodes to ensure a relatively fair memory access by different applications. For example, any increase in a host workload will increase its memory usage and it may be difficult to identify which devices may have additional memory to accommodate the increased memory usage. In addition, existing memory disaggregation approaches generally do not consider the diverse characteristics of the heterogeneous memory devices in satisfying different performance demands of various applications in today's data centers.

### BRIEF DESCRIPTION OF THE DRAWINGS

The features and advantages of the embodiments of the present disclosure will become more apparent from the detailed description set forth below when taken in conjunction with the drawings. The drawings and the associated descriptions are provided to illustrate embodiments of the disclosure and not to limit the scope of what is claimed.

FIG. 1 is a block diagram of an example system for implementing disaggregated memory management for Virtual Machines (VMs) according to one or more embodiments.

FIG. 2 is a block diagram of example devices in the system of FIG. 1 according to one or more embodiments.

FIG. 3 illustrates an example of memory usage information according to one or more embodiments.

FIG. 4 illustrates an example of memory performance information according to one or more embodiments.

FIG. 5 illustrates an example of memory device information according to one or more embodiments.

FIG. 6 is a flowchart for a memory usage adjustment process for an application according to one or more embodiments.

FIG. 7 is a flowchart for a memory usage adjustment process for multiple applications based on memory request performance information according to one or more embodiments.

FIG. 8 is a flowchart for a memory usage estimation process according to one or more embodiments.

FIG. 9 is a flowchart for a memory usage adjustment notification process according to one or more embodiments.

FIG. 10 is a flowchart for a congestion notification process according to one or more embodiments.

FIG. 11 is a flowchart for a memory usage adjustment process based on at least one of memory request rates and memory allocations received from a network controller according to one or more embodiments.

FIG. 12 is a flowchart for adjusting memory usage by a network controller according to one or more embodiments.

### DETAILED DESCRIPTION

In the following detailed description, numerous specific details are set forth to provide a full understanding of the present disclosure. It will be apparent, however, to one of ordinary skill in the art that the various embodiments disclosed may be practiced without some of these specific details. In other instances, well-known structures and techniques have not been shown in detail to avoid unnecessarily obscuring the various embodiments.

### Example System Environments

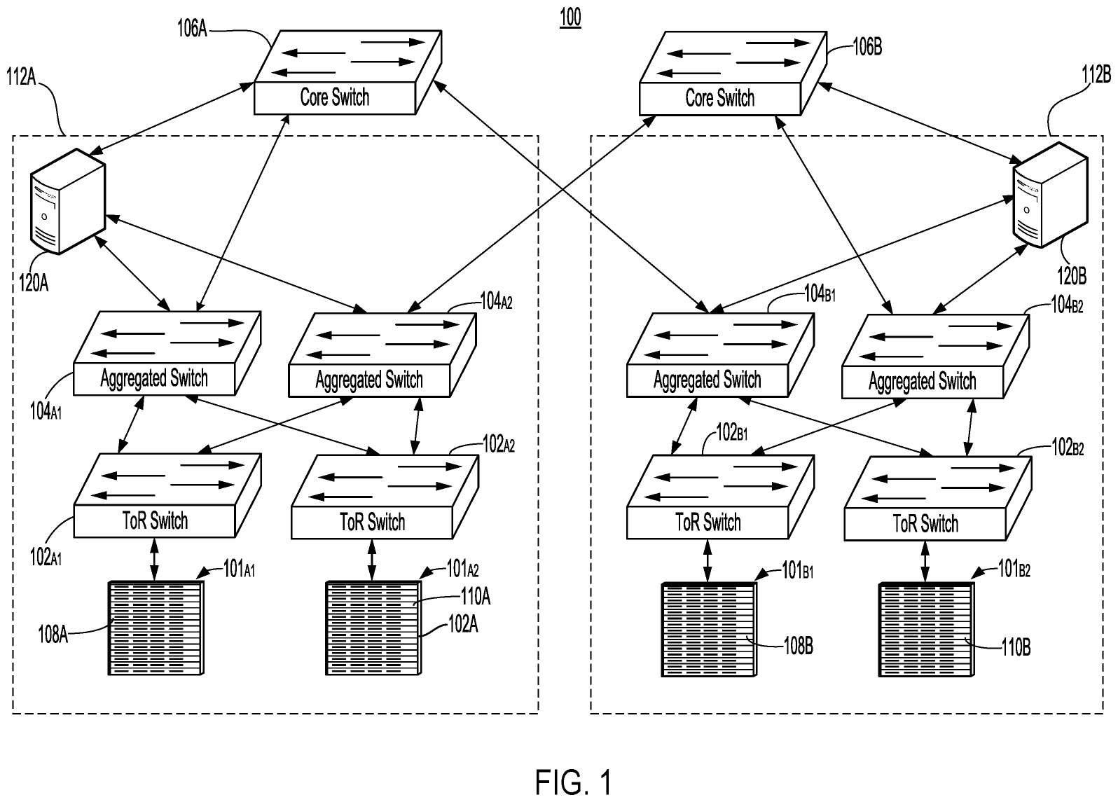

FIG. 1 illustrates an example system 100 for implementing disaggregated memory management for Virtual Machines (VMs) according to one or more embodiments. As shown in FIG. 1, racks 101_{A1}, 101_{A2}, 101_{B1}, and 101_{B2} use Top of Rack (ToR) switches 102_{A1}, 102_{A2}, 102_{B1}, and 102_{B2}, respectively, to communicate with network devices in system 100. Each rack 101 includes one or more network devices, such as servers 108A and 108B that can access shared memory in other network devices, such as memory devices 110A and 110B or another server providing shared memory. In some implementations, system 100 in FIG. 1 may be used as at least part of a data center and/or cloud architecture for applications executed by servers in system 100, such as for distributed machine learning or big data analysis.

Servers 108 can include, for example, processing nodes, such as Central Processing Units (CPUs), Application Specific Integrated Circuits (ASICs), Graphics Processing Units (GPUs), or other processing units that execute applications that access memory that may be local to the server and/or external to the server, such as an external shared memory at a memory device 110 or at another server. In this regard, memory devices 110 can include, for example, Solid-State Drives (SSDs), Hard Disk Drives (HDDs), Solid-State Hybrid Drives (SSHDs), ASICs, Dynamic Random Access Memory (DRAM), or other memory devices, such as solid-state memories, that are made available to servers in system 100.

While the description herein refers to solid-state memory generally, it is understood that solid-state memory may comprise one or more of various types of memory devices such as flash integrated circuits, NAND memory (e.g., Single-Level Cell (SLC) memory, Multi-Level Cell (MLC) memory (i.e., two or more levels), or any combination thereof), NOR memory, Electrically Erasable Programmable Read Only Memory (EEPROM), other discrete Non-Volatile Memory (NVM) chips, or any combination thereof. In other implementations, memory devices 110 and/or servers 108 may include Storage Class Memory (SCM), such as, Chalcogenide RAM (C-RAM), Phase Change Memory (PCM), Programmable Metallization Cell RAM (PMC-RAM or PMCm), Ovonic Unified Memory (OUM), Resistive RAM (RRAM), Ferroelectric Memory (FeRAM), Magnetoresistive RAM (MRAM), 3D-XPoint memory, and/or other types of solid-state memory, for example.

The network devices in system 100 can communicate via, for example, a Storage Area Network (SAN), a Local Area Network (LAN), and/or a Wide Area Network (WAN), such as the Internet. In this regard, one or more of racks 101, ToR switches 102, aggregated switches 104, core switches 106, and/or network controllers 120 may not be physically co-located. Racks 101, TOR switches 102, aggregated switches 104, core switches 106, and/or network controllers 120 may communicate using one or more standards such as, for example, Ethernet and/or Non-Volatile Memory express (NVMe).

As shown in the example of FIG. 1, each of racks 101_{A1}, 101_{A2}, 101_{B1}, and 101_{B2} is connected to a ToR switch or edge switch 102. In other implementations, each rack 101 may communicate with multiple ToR or edge switches 102 for redundancy.

Aggregated switches 104_{A1} and 104_{A2} route messages between the ToR switches 102A and core switch 106A and network controller 120A. In some implementations, racks 101_{A1} and 101_{A2} with TOR switches 102_{A1} and 102_{A2}, aggregated switches 104_{A1} and 104_{A2}, and network controller 120A form cluster 112A of network devices in system 100.

Similarly, aggregated switches 104_{B1} and 104_{B2} route messages between the ToR switches 102B and core switch 106B and network controller 120B. In some implementations, racks 101_{B1} and 101_{B2} with TOR switches 102_{B1} and 102_{B2}, aggregated switches 104_{B1} and 104_{B2}, and network controller 120B form cluster 112B of network devices in system 100. Core switches 106A and 106B can include high capacity, managed switches that route messages between clusters 112A and 112B.

Those of ordinary skill in the art will appreciate that system 100 can include many more network devices than those shown in the example of FIG. 1. For instance, system 100 may include other clusters of racks 101, ToR switches 102, aggregated switches 104, and/or network controllers.

Network controllers 120 can set memory request rates and/or memory allocations (e.g., address ranges of shared memory) for applications being executed by servers in clusters 112A and 112B. In some implementations, one or both of network controllers 120A and 120B may also serve as a Software Defined Networking (SDN) controller that manages control of data flows in system 100 between the switches.

As discussed in more detail below, network controllers 120 can collect memory usage information and/or memory request performance information concerning the shared memory access of different applications executed by VMs running at servers in system 100. Network controllers 120 may use the memory usage information and/or memory request performance information concerning workload or demand of the different memories available as shared memory in the disaggregated memory system to set memory request rates and/or memory allocations that are sent to the servers executing the applications to adjust their usage of the shared memory. The network controllers 120 may also consider memory device information received from the network devices providing shared memory in setting the memory request rates and/or memory allocations for the applications.

In addition, each server (e.g., a server 108) can use a Virtual Switching (VS) kernel module to determine usage of its own local shared memory and determine memory request performance information for the different applications accessing the shared memory of the server. As discussed in more detail below, the server can use a VS controller to set or adjust memory request rates and/or memory allocations for the applications executed by the server and for applications executed by remote servers accessing the shared memory provided by the server.

Those of ordinary skill in the art will appreciate with reference to the present disclosure that other implementations may include a different number or arrangement of racks 101, ToR switches 102, aggregated switches 104, core switches 106, and network controllers than shown in the example of FIG. 1. In this regard, system 100 in FIG. 1 is for illustration purposes, and those of ordinary skill in the art will appreciate that system 100 may include many more racks 101, switches or routers than shown in the example of FIG. 1. In some variations, network controllers 120 may be omitted or one network controller 120 may be used instead of two. As noted above, network controllers 120 in some implementations may also serve as SDN controllers that manage control of the flows in system 100 among the switches.

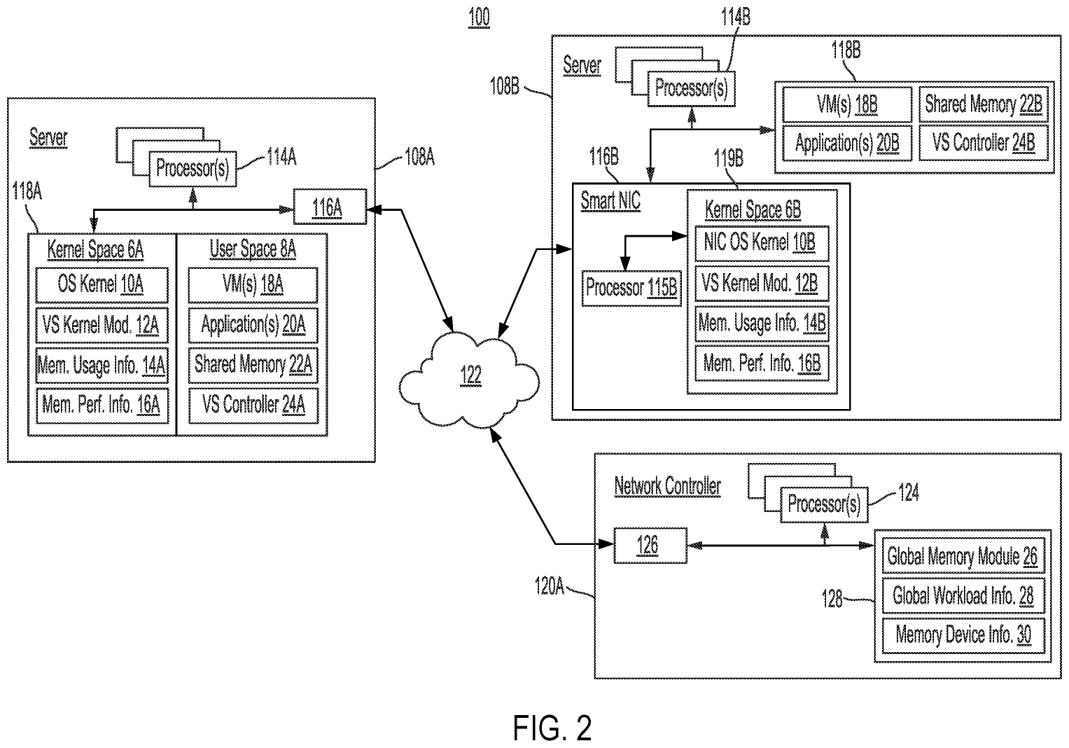

FIG. 2 is a block diagram of example devices in system 100 of FIG. 1 according to one or more embodiments. Each of servers 108A and 108B in the example of FIG. 2 includes one or more processors 114, a network interface 116, and a memory 118. These components of servers 108 may communicate with each other via a bus, which can include, for example, a Peripheral Component Interconnect express (PCIe) bus. In some implementations, servers 108 may be NVMe® over Fabric (NVMe-oFT) network devices configured to communicate with other network devices, such as other servers and memory devices 110 in FIG. 1, using NVMe messages (e.g., NVMe commands and responses) that may be, for example, encapsulated in Ethernet packets using Transmission Control Protocol (TCP). In this regard, network interfaces 116A and 116B of servers 108A and 108B, respectively, may include Network Interface Cards (NICs), network interface controllers, or network adapters.

In the example of FIG. 2, server 108B includes smart NIC 116B as its network interface. As discussed in more detail below, smart NIC 116B includes its own processor 115B and memory 119B that can be used for managing different flows of packets between VMs, determining memory usage information and memory request performance information, and/or responding to memory messages from different VMs. The arrangement of using smart NIC 116B for the operations discussed herein can improve the performance of server 108B by offloading such operations from a processor 114B of server 108B to smart NIC 116B. In some implementations, smart NIC 116B may also serve as an NVMe controller for controlling operation of memory 118B, which can be an NVMe device.

As used herein, memory messages can refer to messages received from or sent to a VM or application concerning memory blocks stored in or to be stored in memory, such as a read request, a write request, a message granting or requesting a permission level for a memory block, or an acknowledgment of a memory operation. In addition, a memory block as used herein can refer to byte-addressable data, such as a cache line.

Processors 114 and 115B in FIG. 1 can execute instructions, such as instructions from one or more user space applications (e.g., applications 20) loaded from memory 118, or from an Operating System (OS) kernel 10. Processors 114 and 115B can include circuitry such as, for example, a CPU, a Graphics Processing Unit (GPU), a microcontroller, a Digital Signal Processor (DSP), an Application-Specific Integrated Circuit (ASIC), a Field Programmable Gate Array (FPGA), one or more RISC-V cores, hard-wired logic, analog circuitry and/or a combination thereof. In some implementations, processors 114 and 115B can include a System on a Chip (SoC), which may be combined with a memory 118 or 119B, respectively.

Memories 118 and 119B can include, for example, a volatile Random Access Memory (RAM) such as Static RAM (SRAM), Dynamic RAM (DRAM), or a non-volatile RAM, or other solid-state memory that is used by processors 114 or 115B. Data stored in memory 118 or memory 119B can include, for example, instructions loaded from an application or from an OS for execution by the processor, and/or data used in executing such applications, such as user data.

Memory 118A of server 108A includes a kernel space 6A that is used by OS kernel 10A and a user space 8A that is used by one or more user space applications 20A, one or more VMs 18A, and Virtual Switching (VS) controller 24A. Kernel space 6A and user space 8A can include separate portions of virtual memory mapped to physical addresses in memory 118A. As will be understood by those of ordinary skill in the art, access to kernel space 6A is generally restricted to OS kernel 10A, its kernel extensions, and other portions of an OS, such as device drivers, while access to user space 8A is available to applications 20A, VMs 18A, and VS controller 24A, in addition to the OS. In this regard, the OS of server 108A or the OS of smart NIC 116B allocates hardware and software resources, such as memory, network, and processing resources of the device. In addition, VS controllers 24 in a user space can allocate resources for different applications, such as by setting or adjusting memory request rates or allocating memory for the applications based on memory usage information and/or memory request performance information determined by VS kernel modules 12.

As shown in FIG. 2, kernel space 6A includes OS kernel 10A, VS kernel module 12A, memory usage information 14A, and memory request performance information 16A. OS kernel 10A can map the shared memory to its local memory 118A, which is shown in FIG. 1 as shared memory 22A. When a new device, such as additional memory, is added to server 108A, OS kernel 10A can manage the newly added memory via a memory controller of a processor 114A and assign a portion of the shared memory to the newly added memory. This can enable the shared memory pool in system 100 to be hot-pluggable to facilitate the addition of memory to the shared memory pool during runtime.

VS kernel module 12A can be used by the kernel to handle requests received from VMs 18A in user space 8A to communicate with other VMs either locally at server 108A or at a different server, such as server 104B. In some implementations, VS kernel module 12A can include an Open vSwitch (OVS) kernel module and can provide a programmable or customizable configuration to perform shared memory management and monitor the flows going through the kernel memory path. As discussed in more detail below, VS kernel module 12A can measure or determine the traffic load of individual applications and the VMs executing the applications, such as a memory request rate, and their resource demands, such as a percentage of usage of local shared memory 22A. Using this information, VS kernel module 12A and VS controller 24A in user space 8A can act as a memory scheduler and controller to serve the applications' memory requests according to their runtime workloads and dynamically adjust their memory request rates and memory allocations.

As a virtual switch, VS kernel module 12A can use flow tables (e.g., match-action tables) and perform table lookup operations in kernel space 6A for requests received from VMs to identify a corresponding socket or port to send a packet for a request. In some implementations, the VS kernel module can use the socket or port to associate the memory request with a particular application executed by the VM. The VS kernel module in the kernel can process packets in the kernel data path, and if the VS kernel module cannot find a match in its flow tables, the kernel path can pass the packet to the VS controller in the user space to process a new flow. The VS controller can then update the VS kernel module's data path tables so that subsequent packets for the flow can be processed in the kernel for faster processing. In some implementations, VS controller 24A can include an OVS controller or agent.

In server 108A, VS kernel module 12A can parse packets received from VMs and use VS queues to route the packets to different VMs locally at server 108A or to a remote server in network 122. In addition, VS kernel module 12A can maintain and update memory usage information 14A and memory request performance information 16A for different applications based at least in part on memory messages it identifies by parsing the packets. In more detail, VS kernel module 12A can parse the header fields of packets to identify memory messages and determine a message type, such as a load or store request for the shared memory. In some implementations, VS kernel module 12A updates memory usage information 14A and memory request performance information based on, for example, a device type, opcode, requestor ID and target ID fields of the received memory message. Memory usage information 14A can include, for example, memory request rates for different applications and an indication of an amount of shared memory 22A being accessed by the applications.

In addition, VS kernel module 12A can monitor hypervisor and hardware performance counters that may be used by OS kernel 10A to determine memory request performance information 16A for the different applications accessing shared memory 22A. Memory request performance information 16A can include, for example, a load to store ratio (e.g., a read-write ratio) for an application, an indication of a number of pending memory requests for the application, and a memory request processing rate for the application.

The memory usage information 14A and the memory request performance information 16A is reported to VS controller 24A so that VS controller 24A can use the collected information to adjust the shared memory request rates of individual applications and their allocations of shared memory 22A based on an overall demand for shared memory 22A. In this regard, VS controller 24A can identify underutilized memory resources allocated to applications that no longer need the memory resources and reassign the memory to other applications that have an increased usage of memory. Such reallocation can help prevent applications from stalling due to not having enough memory. In some implementations, VS controller 24A can also enable live VM migration to satisfy memory requirements that may exceed a threshold amount of shared memory 22A for an application by migrating the VM to a different server.

In addition, VS kernel module 12A or VS controller 24A may retain previous memory usage information for a predetermined period after an application completes execution. VS controller 24A may check whether previous memory usage information is available when a new application initializes to make an initial memory allocation and set an initial shared memory request rate for the application based on such retained memory usage information. This use of previous memory usage information for the application can ordinarily provide a better estimate of future memory demand for the application.

Server 108B differs from server 108A in the example of FIG. 2 in that server 108B uses VS kernel module 12B in a kernel space 6B of memory 119B in its smart NIC 116B for updating memory usage information 14B and memory request performance information 16B. As with VS kernel module 12A of server 108A, VS kernel module 12B of server 108B performs other shared memory management operations, such as sending memory request rates or memory allocations set by VS controller 24B to VMs. As shown in FIG. 1, smart NIC 116B includes its own processor 115B and memory 119B that are used as a hardware offload from processors 114B and memory 118B for operations related to the disaggregated memory system and the data accessed in shared memory 22B. This arrangement can further improve the performance of server 108B by freeing up processing resources and memory for processors 114B.

Smart NIC 116B can include, for example, an SoC that includes both processor 115B and memory 119B. In the example of server 108B, smart NIC 116B includes its own NIC OS kernel 10B that allocates resources of smart NIC 116B and memory 118B. In some implementations, memory 118B is an NVMe memory device that stores shared memory 22B for the disaggregated memory system and executes one or more user space applications 20B, one or more VMs 18B, and VS controller 24B in a user space of memory 118B. In some implementations, VS controller 24B can include an OVS controller or agent that can provide a programmable or customizable configuration. Each of the one or more VMs 18B can run one or more user space applications 20B and use VS controller 24B to interface with VS kernel module 12B in kernel space 6B.

VS kernel module 12B can be used by the kernel to handle packets received from VMs 18B to communicate with other VMs either locally at server 108B or at a different server, such as server 108A. In some implementations VS kernel module 12B can include, for example, an OVS kernel module that can provide a programmable or customizable configuration in the way packets are processed and for the memory monitoring and memory management operations disclosed herein. As a virtual switch, VS kernel module 12B can use flow tables (e.g., match-action tables) and perform table lookup operations in kernel space 6B according to requests received from VMs to identify different sockets or ports for routing the requests.

Network controller 120A provides global adjustment of memory request rates and/or memory allocations for different applications for disaggregated memory throughout system 100. In some implementations, network controller 120B in FIG. 1 may serve as a backup network controller for redundancy. In other implementations, each of network controller 120A and 120B may provide memory usage adjustments for the VMs running in their respective clusters 112A and 112B.

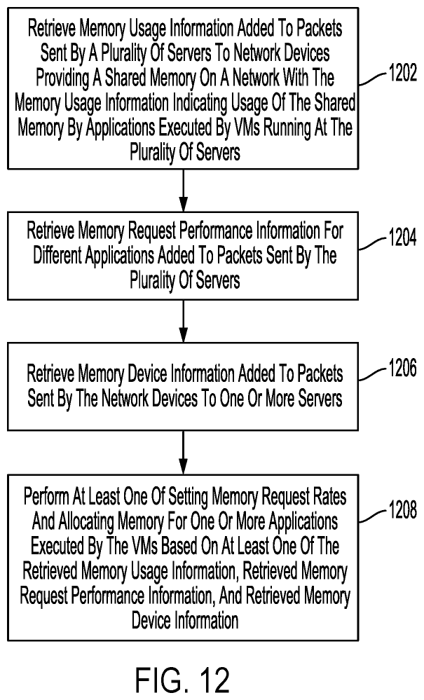

As discussed in more detail below with reference to FIG. 12, network controller 120A retrieves memory usage information and memory request performance information added to packets sent by servers to set one or more memory request rates and/or memory allocations for applications executed by VMs. The memory usage information and the memory request performance information can be added to the packets by VS kernel modules at the servers by piggybacking the information for the server onto outgoing packets to reduce network traffic overhead, as compared to periodically sending dedicated messages for providing the memory usage information and memory request performance information from all of the servers to the network controllers. Network controller 120A can instead periodically snoop the network traffic at switches, such as aggregated switches 104 or ToR switches 102, to retrieve the memory usage information and memory request performance information. The retrieved memory usage information and memory request performance information is collected by global memory module 26 of the network controller as global workload information 28 to determine memory usage and memory request performance for applications across the system.

In addition, global memory module 26 may also consider memory device information, such as a number of pending requests for a memory device, a capacity or average capacity of queues for a memory device's pending requests, and a rate for processing memory requests by the memory device. This information may be added to outgoing packets from memory devices (e.g., memory devices 110 in FIG. 1) or by servers that provide respective shared memories. Network controller 120A can periodically snoop the network traffic at switches to retrieve the memory device information from the packets. Global memory module 26 collects the retrieved memory device information as memory device information 30, which may also include indications of congestion retrieved from snooped packets on the network. In this regard, a server or a memory device may add an indication of congestion to a field in a TCP packet, for example, to indicate that a queue or average queue length for pending requests at its shared memory have reached a threshold level, such as 75% full.

Global workload information 28 and memory device information 30 can be used by global memory module 26 to set or adjust one or more shared memory request rates and/or memory allocations for one or more applications executed by VMs to better balance the traffic flows between the network devices and the usage of the shared memory pool among the applications. Network controller 120A can send the set memory request rates or memory allocations for the applications to the servers running the VMs that execute the applications to better balance usage of the shared memory across the system.

Processor or processors 124 of network controller 120A can include circuitry such as a CPU, a GPU, a microcontroller, a DSP, an ASIC, an FPGA, hard-wired logic, analog circuitry and/or a combination thereof. In some implementations, processor or processors 124 can include an SoC, which may be combined with one or both of memory 128 and interface 126. Memory 128 can include, for example, a volatile RAM such as DRAM, a non-volatile RAM, or other solid-state memory that is used by processor(s) 124 to store data. Network controller 120A communicates with network devices, such as servers 108 and memory devices 110, via interface 126, which may interface according to a standard, such as Ethernet. In some implementations, network controller 120A is an SDN controller with other modules for managing traffic flows.

Those of ordinary skill in the art will appreciate with reference to the present disclosure that other implementations of servers 108 or network controller 120A may include a different arrangement than shown in the example of FIG. 2. In this regard, the modules, programs, and data structures shown in FIG. 2 may differ in other implementations. For example, servers 108 can include a different number of modules than shown in FIG. 2, such as in implementations where different programs may be used for monitoring memory usage and sending set memory request rates, memory allocations, and congestion notifications to VMs. As another example variation, memory usage information 14 and memory request performance information 16 may be combined into a single data structure or may form part of another data structure stored in a kernel space, such as a flow table.

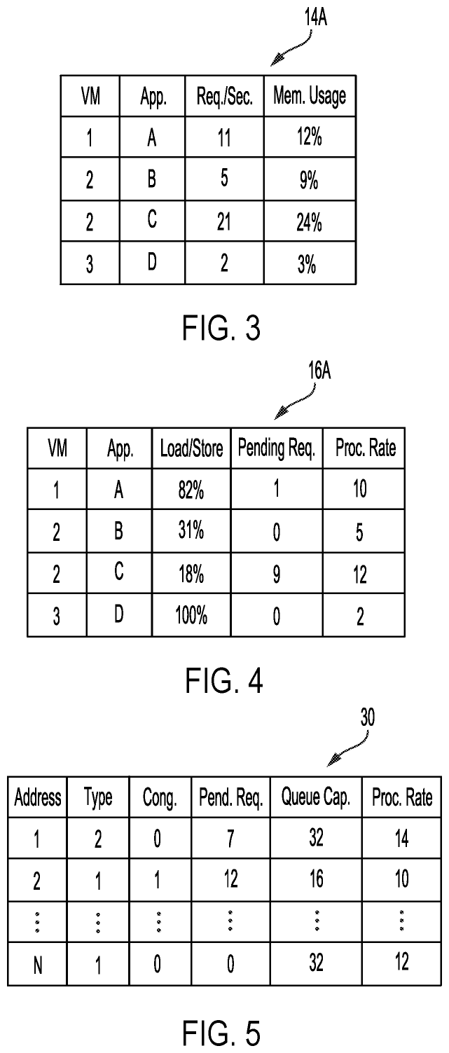

FIG. 3 illustrates an example of memory usage information 14A according to one or more embodiments. In the example of FIG. 3, memory usage information 14A may be stored as a table or other type of data structure such as a Key Value Store (KVS) in kernel space 6A of server 108A. Memory usage information 14A includes information on the usage of shared memory 22A at server 108A by different applications executed locally by VMs 18A at server 108A and/or applications executed remotely by VMs at other servers that access shared memory 22A at server 108A. Memory usage information 14B stored by server 108B may include similar information as that shown for memory usage information 14A of FIG. 3, but with memory usage information associated with applications accessing shared memory 22B at server 108B.

As shown in FIG. 3, memory usage information 14A includes application identifiers (e.g., A, B, C, D) that identify different applications being executed by VMs that are accessing shared memory 22A. Memory usage information 14A also includes an identifier for the VM executing the application, which can include an IP address or other address for the VM in some implementations.

VS kernel module 12A in some implementations may also retain some previous usage information in memory usage information 14A or in a different data structure for previously executed applications to help predict or estimate future memory usage when an application is reinitiated. For example, if an application is initiated by OS kernel 10A and previous memory usage information in memory usage information 14A indicates that the application previously used a large portion of shared memory 22A, VS kernel module 12A or VS controller 24A may adjust memory usage to free a larger portion of shared memory 22A to allocate to the application. VS kernel module 12A determines and updates memory usage information 14A and provides this information to VS controller 24A, which sets and adjusts memory request rates and memory allocations for the different applications accessing shared memory 22A based on the memory usage information to balance the memory demands among the applications.

In the example of FIG. 3, the memory usage information determined and updated by VS kernel module 12A in memory usage information 14A includes a measured memory request rate expressed as memory requests per second and a measured memory usage expressed as a percentage of the total available capacity of shared memory 22A. In other implementations, the memory request rate and/or the memory usage may be expressed differently, such as by indicating an average number of memory requests for a different time period or with different levels for memory usage indicated as low, medium, and high, for example. As another example variation, other implementations of memory usage may instead indicate a percentage or amount of the memory allocated to the application that is currently being used by the application. VS kernel module 12A may determine the memory request rates and the memory usage for the different applications by parsing packets received in the kernel data path to identify the memory requests and associate them with different applications and VMs.

As shown in the example of FIG. 3, applications A and C have higher memory request rates and memory usage than applications B and D. As a result, VS controller 24A may use this information to adjust its allocation of shared memory 22A to provide a larger portion to applications A and C and may set memory request rates that are lower for applications A and C to provide a more balanced use of shared memory 22A.

As will be appreciated by those of ordinary skill in the art with reference to the present disclosure, memory usage information 14A may include different information than shown in FIG. 3. For example, some implementations of memory usage information 14A may instead flag applications that have a memory usage or memory request rate greater than a threshold level. As another example variation, other implementations of memory usage information 14A can be combined with memory request performance information into one data structure.

FIG. 4 illustrates an example of memory request performance information 16A according to one or more embodiments. In the example of FIG. 4, memory request performance information 16A may be stored as a table or other type of data structure such as a KVS in kernel space 6A of server 108A. Memory request performance information 16A includes information on the performance of memory requests at shared memory 22A for different applications executed locally by VMs 18A at server 108A and/or applications executed remotely by VMs at other servers that access shared memory 22A at server 108A. Memory request performance information 16B stored by server 108B may include similar information as that shown for memory request performance information 16A of FIG. 4, but with memory request performance information associated with applications accessing shared memory 22B at server 108B.

As shown in FIG. 4, memory request performance information 16A includes application identifiers (e.g., A, B, C, D) that identify different applications being executed by VMs that are accessing shared memory 22A, as with the example of memory usage information 14A discussed above. Memory request performance information 16A also includes an identifier for the VM executing the application, which can include an IP address or other address for the VM in some implementations. VS kernel module 12A determines and updates memory request performance information 16A and provides this information to VS controller 24A, which sets and adjusts memory request rates and memory allocations based on the memory request performance information for the different applications accessing shared memory 22A to balance the memory demands among the applications.

VS kernel module 12A in some implementations may also retain some previous memory request performance information in memory request performance information 16A or in a different data structure for previously executed applications to help predict or estimate future memory demands when an application is reinitiated. For example, if an application is initiated by OS kernel 10A and previous memory request performance information in memory request performance information 16A indicates that the application previously issued more store or write commands than load or read commands, VS controller 24A may determine to lower the memory request rate for another currently executing application that also issues more store or write commands than load or read commands to better balance access to a write queue for shared memory 22A.

In the example of FIG. 4, the memory request performance information determined and updated by VS kernel module 12A includes a load to store ratio for requests issued by the application, a number of pending memory requests issued by the application, and a processing rate for memory requests issued by the application. In other implementations, these memory performance metrics may be expressed differently, such as by indicating different levels for the load to store ratio, pending requests, or processing rate with low, medium, and high, for example. As another example variation, memory performance information may provide counts for read requests and write requests issued within a predetermined period of time in addition to or in place of a load to store ratio. VS kernel module 12A may determine the memory request performance information for the different applications by accessing hypervisor and/or hardware performance counters and associating performance counters with different applications and VMs.

As shown in the example of FIG. 4, application C has 9 pending requests and therefore may be delayed in its operation. As a result, VS controller 24A may use this information to increase the memory request rate for application C. As another example, VS controller 24A may lower the memory request rate for application D in favor of increasing the memory request rate for application A since both applications have a higher load to store ratio and application A has a higher memory demand than application D.

As will be appreciated by those of ordinary skill in the art with reference to the present disclosure, memory request performance information 16A may include different information than shown in FIG. 4. For example, some implementations of memory request performance information 16A may instead flag applications that have a greater number of pending memory requests above a threshold number of pending memory requests.

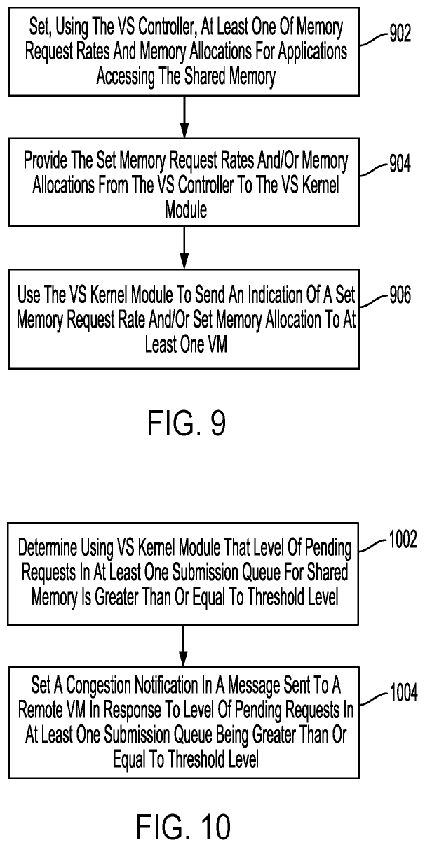

As noted above, other implementations of memory request performance information 16A can be combined with memory usage information 14A. In this regard, VS kernel module 12A can provide at least a portion of memory usage information 14A and memory request performance information 16A to network controller 120A and/or network controller 120B by piggybacking the memory usage information and memory request performance information on packets sent via network 122. In other implementations, VS kernel module 12A may periodically send updated memory usage information and memory request performance information to one or more network controllers 120 instead of adding this information to other packets. In addition, and as discussed in more detail below with reference to FIG. 9, VS kernel module 12A can send the memory request rates and/or memory allocations set by VS controller 24A to remote servers running VMs that access shared memory 22A to inform them of the memory request rates and/or memory allocations. VS kernel module 12A can also send out congestion indications with packets to indicate to other servers and to network controllers that the queues for memory requests have reached or exceeded a threshold level, which can be used by the remote servers or network controllers to redirect memory requests to other shared memories in the disaggregated memory pool.

FIG. 5 illustrates an example of memory device information 30 stored at network controller 120A according to one or more embodiments. In addition to memory device information 30, network controller 120A can also store global workload information 28, which can include some or all of the memory usage information and memory request performance information collected by the network controller for servers in the system. Memory device information 30 can be sent by network devices (e.g., memory devices and servers) that provide shared memory for the disaggregated memory system. In some cases, the network devices may add this information to packets that are sent to other network devices, and network controller 120A retrieves the memory device information by snooping network traffic at the switches. In other cases, the memory device information may be sent directly to the network controller by the network devices providing the shared memory.

Global memory module 26 of network controller 120A uses memory device information 30 and global workload information 28 to periodically adjust memory request rates and/or memory allocations for different applications in system 100 to balance the memory usage and memory request performance on a larger scale that may consider additional bottlenecks such as network congestion or unbalanced workloads for different shared memories, as compared to the management of shared memory at the server level.

As shown in FIG. 5, memory device information 30 includes addresses for the different shared memories, a type for the shared memory, a congestion indication for the shared memory, a number of pending requests for the shared memory, a capacity or average capacity for one or more queues for the shared memory, and a processing rate or average processing rate for memory requests queued at the shared memory.

In the example of FIG. 5, address A may correspond to shared memory 22A at server 108A, while address B may correspond to shared memory 22B located at server 108B, and address N may correspond to a shared memory at memory device 110A, for example. In some implementations, memory device information 30 may further include an identifier for the server rack 101 and/or the network device providing the shared memory associated with the memory device information.

The types of memory can correspond to, for example, a DRAM, an NVMe flash memory, an MRAM, or other type of SCM. The different types of memory can have different characteristics such as different read and write latencies, which global memory module 26 can consider in setting or adjusting memory request rates for different applications accessing a particular shared memory. The network controller can also use the congestion indications to lower memory request rates or change memory allocations for applications accessing shared memories that have indicated congestion, which can result from pending requests in one or more queues for the shared memory exceeding a threshold level.

The pending requests in memory device information 30 can indicate an average number of pending commands or requests that are waiting to be performed in the shared memory. In some implementations, the pending requests may correspond to an average NVMe submission queue length from among multiple NVMe submission queues. In other implementations, memory device information 30 may include separate average queue lengths for read requests and for write requests.

The processing rate in memory device information 30 can include a number of pending requests processed by the memory device in a predetermined period. This may indicate an overall number of memory requests or an average number of memory requests for different queues. In other implementations, memory device information 30 may include separate processing rates for read or load requests and for write or store requests.

As will be appreciated by those of ordinary skill in the art with reference to the present disclosure, memory device information 30 may include different information than shown in FIG. 5. For example, memory device information 30 in other implementations may include an average completion time for requests or separate read and write performance information.

### Example Processes

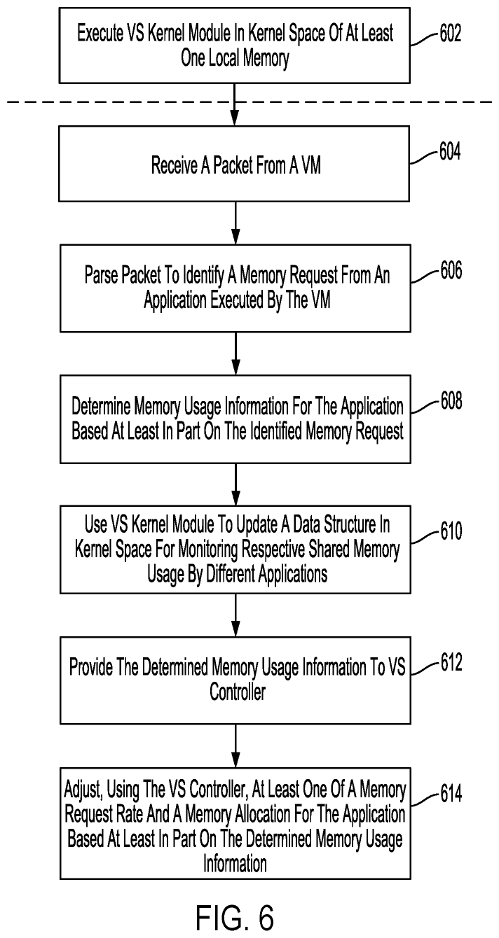

FIG. 6 is a flowchart for a memory usage adjustment process for an application according to one or more embodiments. The process of FIG. 6 can be performed by, for example, at least one processor 114A of server 108A executing VS kernel module 12A and VS controller 24A, or at least one processor 114B of server 108B executing VS kernel module 12B and VS controller 24B.

In block 602, at least one processor of the server executes a VS kernel module (e.g., VS kernel module 12A) in a kernel space of the server. The VS kernel module may be part of an OS kernel executed by a processor of the server or by a processor of a smart NIC of the server. In some implementations, the VS kernel module may be configured using OVS. The execution of the VS kernel module continues throughout the process of FIG. 6 as indicated by the dashed line after block 602 in FIG. 6.

In block 604, the VS kernel module receives a packet from a VM. The VM may be executing at the server or may be executing at a remote server that accesses a shared memory of the server via a network. The VS kernel module monitors data flows or packets in a kernel memory data path between the VMs and the memory device providing the shared memory.

In block 606, the VS kernel module parses the packet to identify a memory message from an application executed by the VM. In this regard, the VS kernel module may be programmable, such as with OVS, to parse packets in an ingress pipeline for data flows of packets. The VS kernel may, for example, parse a header field of each packet to determine whether the packet includes a memory message and further determine a message type using an op code in the header indicating that the memory message is a memory request.

In block 608, the VS kernel module determines shared memory usage information for the application that issued the request based at least in part on the identified memory request. In some implementations, the VS kernel module may use other information from the memory request to associate the request with a currently executing application. The shared memory usage can include, for example, measuring a memory request rate for the application and an amount of the shared memory currently being used by the application, which is typically less than the memory allocated to the application.

In block 610, the VS kernel module updates a data structure in a kernel space of the server for monitoring respective shared memory usage by different applications accessing the shared memory at the server. The data structure may correspond to, for example, memory usage information 14A in FIG. 3 discussed above. The VS kernel module may also remove memory usage information from the data structure for applications that are no longer active or that may not have been active for a predetermined period of time.

In block 612, the VS kernel module provides memory usage information to a VS controller (e.g., VS controller 24A). The VS kernel module can provide the VS controller with updates on the changing memory demands of the different applications accessing the shared memory. The VS controller can include, for example, an OVS controller that can be configured to adjust or set memory request rates and memory allocations for different applications accessing the shared memory.

In block 614, the VS controller adjusts at least one of a memory request rate and a memory allocation for the application based at least in part on the determined memory usage information received from the VS kernel module. In some cases, the VS controller may also adjust the memory request rates for other applications based on the changing memory demands of the application.

Those of ordinary skill in the art will appreciate with reference to the present disclosure that the memory request adjustment process of FIG. 6 may differ in other implementations. For example, the updating of a data structure in block 610 may be omitted in some implementations such that memory usage information is passed directly to the OVS controller, which may instead manage the memory usage information.

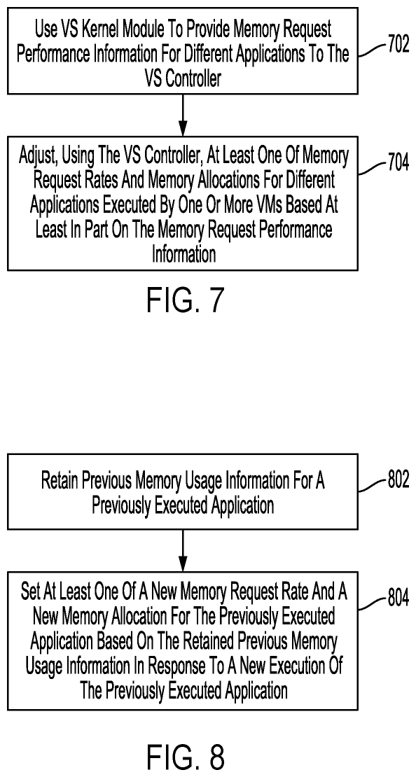

FIG. 7 is a flowchart for a memory usage adjustment process for multiple applications using memory request performance information according to one or more embodiments. The process of FIG. 7 can be performed by, for example, at least one processor 114A of server 108A executing VS kernel module 12A and VS controller 24A, or at least one processor 114B of server 108B executing VS kernel module 12B and VS controller 24B. The memory usage adjustment process of FIG. 7 can be in addition to the adjustment of memory usage performed by the process of FIG. 6 in that the VS controller can consider the memory request performance information in addition to memory usage information in some implementations of the process of FIG. 6.

In block 702, the VS kernel module provides memory request performance information for different applications to the VS controller. As discussed above with respect to the example of memory request performance information 16A shown in FIG. 4, the memory request performance information can include performance information accessible by the VS kernel module, such as performance counters used by a hypervisor that manages the VMs and/or hardware performance counters used by the OS of the server. The memory request performance information can include, for example, a load to store ratio (or store to load ratio) for the different applications, a number of pending requests for the applications, and a processing rate for memory requests issued by the different applications.

In block 704, the VS controller adjusts at least one of memory request rates and memory allocations for different applications executed by one or more VMs based at least in part on the memory request performance information. The different applications may run on VMs locally at the server or may run at remote servers. After setting the memory request rates and/or memory allocations, the VS controller provides the set memory request rates and/or memory allocations to the VS kernel module in the kernel space, which provides the new memory request rates and/or new memory allocations to the VMs.

FIG. 8 is a flowchart for a memory usage estimation process according to one or more embodiments. The process of FIG. 8 can be performed by, for example, at least one processor 114A of server 108A executing VS kernel module 12A and VS controller 24A, or at least one processor 114B of server 108B executing VS kernel module 12B and VS controller 24B.

In block 802, the VS kernel module retains shared memory usage information for a previously executed application. As discussed above, the VS kernel module may update a data structure in a kernel space and determine how long to retain shared memory usage information in the data structure after an application completes execution. In some implementations, the memory usage information may be kept for a predetermined period of time or may be kept longer for applications that have been executed more frequently since such applications are more likely to be executed again.

In block 804, in response to a new execution of the previously executed application, the VS controller sets at least one of a new memory request rate and a new memory allocation for the previously executed application based on the retained previous memory usage information. In some implementations, the VS kernel module may have access to system calls in the kernel to identify a reinitialization of the previously executed application. The VS kernel may then provide the retained memory usage information to the VS controller, which sets a new memory request rate and/or a new memory allocation (e.g., address range in shared memory) for the application based on its previous memory usage, which can provide an improved estimate of the memory usage by the application as compared to providing a default memory allocation and memory request rate.

FIG. 9 is a flowchart for a memory usage adjustment notification process according to one or more embodiments. The process of FIG. 9 can be performed by, for example, at least one processor 114A of server 108A executing VS kernel module 12A and VS controller 24A, or at least one processor 114B of server 108B executing VS kernel module 12B and VS controller 24B.

In block 902, the VS controller sets at least one of memory request rates and memory allocations for applications accessing the shared memory at the server. As discussed above with reference to the memory usage adjustment processes of FIGS. 6 and 7, the memory request rates and/or memory allocations can be set based on memory usage information and memory request performance information received from the VS kernel module for the different applications.

In block 904, the VS controller provides the set memory request rates and/or memory allocations to the VS kernel module. The VS kernel module in block 906 sends one or more indications of the memory request rates and/or memory allocations set by the VS controller to the corresponding VMs that execute the associated applications. The applications then adjust their memory request rates based on the indications received from the VS kernel. In some implementations, the VS kernel module can add the memory request rates and/or memory allocations set by the VS controller to packets that are sent to the VMs that execute the associated applications. In some cases, this can include packets that are sent to remote servers running VMs that are remotely accessing the shared memory.

FIG. 10 is a flowchart for a congestion notification process according to one or more embodiments. The process of FIG. 10 can be performed by, for example, at least one processor 114A of server 108A executing VS kernel module 12A, or at least one processor 114B of server 108B executing VS kernel module 12B.

In block 1002, the VS kernel module determines that the level of pending requests for at least one submission queue for the shared memory is greater than or equal to a threshold level. In some implementations, the threshold level can indicate a certain percentage of fullness of the queue(s), such when the queue(s) are 75% full with pending requests and only have a remaining capacity of 25% for additional memory requests. The VS kernel module in some implementations may determine that the level of pending requests is greater than or equal to the threshold level when one of the submission queues for the shared memory reaches the threshold level of pending requests. In other implementations, the VS kernel module may determine that the level of pending requests is greater than or equal to the threshold level when an average level of pending requests in all submission queues for the shared memory have reached the threshold level.

In block 1004, the VS kernel module sets a congestion notification in a message sent to a remote VM in response to determining that the level of pending requests for the submission queue(s) has reached or exceeded the threshold level. The VS kernel module can add an indicator, such as by setting a congestion field in a TCP packet, for a message sent to a remote server running a VM that executes an application that accesses the shared memory. In some cases, the message may also include a memory request rate set by the VS controller lowering the memory request rate for the application executed by the remote VM. As discussed above with reference to FIG. 5, a network controller may also retrieve the congestion indication added to the message via a switch in the network and update memory device information 30 used to adjust memory request rates and/or memory allocations across a cluster or system.

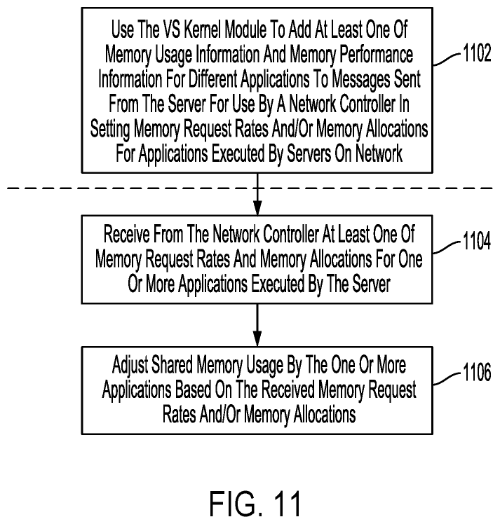

FIG. 11 is a flowchart for a memory usage adjustment process based on at least one of memory request rates and memory allocations received from a network controller according to one or more embodiments. The process of FIG. 11 can be performed by, for example, at least one processor 114A of server 108A executing VS kernel module 12A and VS controller 24A, or at least one processor 114B of server 108B executing VS kernel module 12B and VS controller 24B.

In block 1102, the VS kernel module adds at least one of memory usage information and memory request performance information for different applications to messages sent from the server to other network devices. The memory usage information can include, for example, some or all of the information discussed above for memory usage information 14A with reference to FIG. 3. The memory request performance information can include, for example, some or all of the information discussed above for memory request performance information 16A with reference to FIG. 4.

The VS kernel module may piggyback or add the memory usage information and/or memory request performance information to packets that are sent for other purposes, such as to return data requested from the shared memory to a remotely executing application or for read requests made to other network devices providing shared memory. The receiving network device may disregard the information added to the message, but a network controller may retrieve this information via a switch in the network and use the retrieved information in setting memory request rates and/or memory allocations for applications executed by servers in a cluster or system.

In block 1104, the VS kernel module receives from the network controller at least one of memory request rates and memory allocations for one or more applications executed by the server. As indicated by the dashed line between blocks 1102 and 1104, the receipt of the memory request rates and/or memory allocations in block 1104 from the network controller may not be in response to sending the memory usage information and memory request performance information in block 1102. Instead, the network controller can collect or aggregate memory usage information and/or memory request performance information, and may also collect or aggregate memory device information, that the network controller uses to determine memory request rates and/or memory allocations that are sent to particular servers informing them of memory request rates and/or memory allocations set by the network controller for the applications executed by VMs at the server.

In some cases, the network controller may change a memory allocation from one shared memory at a first network device to a different shared memory at a different network device to better balance the demand for memory in the system or a cluster, or to improve memory performance by lessening the load on a shared memory that may be congested. The memory allocation may be indicated by the network controller with, for example, an address range or address for a different shared memory.

In block 1106, the memory usage for one or more applications executed by the server is adjusted based on the one or more memory request rates and/or memory allocations received from the network controller. In some implementations, the VS kernel module may provide the new memory request rates or new memory allocations received from the network controller to the VS controller, which adjusts the memory demand and may also adjust memory allocation for the different applications based on the new settings from the network controller. In other implementations, the VS kernel module may provide the memory request rates received from the network controller directly to the VMs executing the applications and provide the VS controller with this information as part of its updated memory usage information.

FIG. 12 is a flowchart for setting memory usage by a network controller according to one or more embodiments. The process of FIG. 12 can be performed by, for example, at least one processor 124 of network controller 120A executing global memory module 26.

In block 1202, the network controller retrieves memory usage information added to packets sent by a plurality of servers to network devices providing a shared memory on a network. The memory usage information indicates a usage of the shared memory by applications executed by VMs running at the plurality of servers. In retrieving the memory usage information, switches in the network may be programmed to identify and extract the memory usage information and forward it to the network controller. As discussed above with reference to FIG. 3, the memory usage information can include, for example, a memory request rate and a memory usage (e.g., percentage of memory) measured or determined by a VS kernel module of the server. The network controller may then add the retrieved memory usage information to a global memory workload (e.g., global workload information 28 in FIG. 2) representing a shared memory workload across a system or cluster of network devices including the plurality of servers.

In block 1204, the network controller retrieves memory request performance information added to packets sent by the plurality of servers to network devices providing shared memory. The memory request performance information indicates the performance of memory requests to shared memory from applications executed by VMs running at the plurality of servers. In retrieving the memory request performance information, switches in the network may be programmed to identify and extract the memory request performance information and forward it to the network controller. As discussed above with reference to FIG. 4, the memory request performance information can include, for example, a load to store ratio (or store to load ratio), a number of pending requests, and a processing rate for the memory requests issued by the application. These metrics can be measured or determined by a VS kernel module of the server using, for example, performance counters provided by a hypervisor or hardware controller of the server. The network controller may then add the retrieved memory request performance information to a global memory workload (e.g., global workload information 28 in FIG. 2) representing a shared memory workload across a system or cluster of network devices including the plurality of servers.

In block 1206, the network controller retrieves memory device information added to packets sent by network devices providing a shared memory in the cluster or system. The network devices can include dedicated memory devices (e.g., memory devices 110 in FIG. 1) and servers that provide a shared memory (e.g., servers 108A and 108B in FIG. 2). The network devices can add the memory device information concerning their portion of the shared memory to packets responding to memory requests received from servers executing applications accessing the shared memory or to other messages sent by the network devices onto the network, such as for memory coherence operations or for namespace processes. The memory device information can indicate a status of the shared memory and can include information, such as, for example, a type of memory device (e.g., flash memory, DRAM, MRAM, SCM) for the shared memory, congestion notification for the shared memory, an average number of pending requests in one or more submission queues for the shared memory, an average capacity of one or more submission queues for the shared memory, and an average processing rate or total processing rate for memory requests processed by the shared memory.

In retrieving the memory device information, switches in the network may be programmed to identify and extract the memory device information and forward it to the network controller. The network controller may then add the retrieved memory device information to an aggregated memory device information (e.g., memory device information 30 in FIG. 2) representing a status of shared memory across a system or cluster of network devices providing the disaggregated memory pool.

In block 1208 of FIG. 12, the network controller using a global memory module performs at least one of setting memory request rates and allocating memory for one or more applications executed by VMs running at the plurality of servers based on at least one of the retrieved memory usage information, the retrieved memory request performance information, and the retrieved memory device information. By setting the one or more memory request rates and allocating memory, the network controller can balance the usage of the disaggregated memory pool among the different applications executing throughout the cluster or network. For example, the network controller may reallocate memory from an application that issues more write or store commands to a different shared memory based on a device type of the newly allocated shared memory being faster at performing write commands than a current shared memory being used by the application. The network controller may then send the memory request rates and/or memory allocations to the different servers executing the applications to inform them of the new memory request rates and/or memory allocations.

The foregoing use of VS kernel modules and VS controllers at servers throughout a network can provide a faster and more dynamic memory allocation that is better suited to the changing memory demands of the applications and the changing status of different shared memories in the disaggregated memory system. By distributing the management of memory usage to servers in the system via a VS module in a kernel space and a VS controller, in addition to one or more network controllers, it is also ordinarily possible to better scale to larger systems that include different types of memory with different performance characteristics. In addition, the sharing of memory usage information, memory request performance information, and memory device information with network controllers can provide a cluster-wide or system-wide view of memory demand to improve an overall performance of applications by reducing memory bottlenecks and providing fairer memory resource sharing among applications in the system.

### OTHER EMBODIMENTS

Those of ordinary skill in the art will appreciate that the various illustrative logical blocks, modules, and processes described in connection with the examples disclosed herein may be implemented as electronic hardware, computer software, or combinations of both. Furthermore, the foregoing processes can be embodied on a computer readable medium which causes processor or controller circuitry to perform or execute certain functions.

To clearly illustrate this interchangeability of hardware and software, various illustrative components, blocks, and modules have been described above generally in terms of their functionality. Whether such functionality is implemented as hardware or software depends upon the particular application and design constraints imposed on the overall system. Those of ordinary skill in the art may implement the described functionality in varying ways for each particular application, but such implementation decisions should not be interpreted as causing a departure from the scope of the present disclosure.

The various illustrative logical blocks, units, modules, processor circuitry, and controller circuitry described in connection with the examples disclosed herein may be implemented or performed with a general purpose processor, a GPU, a DSP, an ASIC, an FPGA or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. Processor or controller circuitry may also be implemented as a combination of computing devices, e.g., a combination of a DSP and a microprocessor, a plurality of microprocessors, an SoC, one or more microprocessors in conjunction with a DSP core, or any other such configuration.

The activities of a method or process described in connection with the examples disclosed herein may be embodied directly in hardware, in a software module executed by processor or controller circuitry, or in a combination of the two. The steps of the method or algorithm may also be performed in an alternate order from those provided in the examples. A software module may reside in RAM memory, flash memory, ROM memory, EPROM memory, EEPROM memory, registers, hard disk, a removable media, an optical media, or any other form of storage medium known in the art. An exemplary storage medium is coupled to processor or controller circuitry such that the processor or controller circuitry can read information from, and write information to, the storage medium. In the alternative, the storage medium may be integral to processor or controller circuitry. The processor or controller circuitry and the storage medium may reside in an ASIC or an SoC.

The foregoing description of the disclosed example embodiments is provided to enable any person of ordinary skill in the art to make or use the embodiments in the present disclosure. Various modifications to these examples will be readily apparent to those of ordinary skill in the art, and the principles disclosed herein may be applied to other examples without departing from the spirit or scope of the present disclosure. The described embodiments are to be considered in all respects only as illustrative and not restrictive. In addition, the use of language in the form of “at least one of A and B” in the following claims should be understood to mean “only A, only B, or both A and B.”

What is claimed is:

1. A server, comprising:
at least one local memory configured to be used at least in part as a shared memory;
a network interface configured to communicate with one or more network devices via a network, the one or more network devices each configured to provide a respective shared memory via the network; and
at least one processor configured to:
execute a Virtual Switching (VS) kernel module in a kernel space of the at least one local memory, the VS kernel module configured to:
receive a packet from a Virtual Machine (VM) executed by the at least one processor or by a processor of a remote server;
parse the packet to identify a memory request from an application executed by the VM;
determine memory usage information for the application based at least in part on the identified memory request;
provide the determined memory usage information to a VS controller executed by the at least one processor; and
adjust, using the VS controller, at least one of a memory request rate and a memory allocation for the application based at least in part on the determined memory usage information.

2. The server of claim 1, wherein the at least one processor is further configured to:
use the VS kernel module to further provide memory request performance information for different applications to the VS controller; and
adjust, using the VS controller, at least one of memory request rates and memory allocations for the different applications executed by one or more VMs based at least in part on the memory request performance information.

3. The server of claim 1, wherein the at least one processor is further configured to:
retain previous memory usage information for a previously executed application; and
in response to a new execution of the previously executed application, set at least one of a new memory request rate and a new memory allocation for the previously executed application based on the retained previous memory usage information.

4. The server of claim 1, wherein the at least one processor is further configured to use the VS controller to adjust memory request rates and memory allocations for applications executed by local VMs running at the server and by remote VMs running at remote servers on the network.

5. The server of claim 1, wherein the at least one processor is further configured to use the VS kernel module to update a data structure in the kernel space for monitoring respective memory usage by different applications.

6. The server of claim 1, wherein the at least one processor is further configured to:
set, using the VS controller, at least one of memory request rates and memory allocations for VMs accessing the shared memory at the least one local memory;
provide the at least one of memory request rates and memory allocations set by the VS controller to the VS kernel module; and
use the VS kernel module to send an indication of at least one of a set memory request rate and a set memory allocation to at least one VM.

7. The server of claim 1, wherein the at least one processor is further configured to:
determine, using the VS kernel module, that a level of pending requests in at least one submission queue for the shared memory is greater than or equal to a threshold level of pending requests; and
in response to determining that the level of pending requests in the at least one submission queue is greater than or equal to the threshold level, set a congestion notification in a message sent to a remote VM.

8. The server of claim 1, wherein the at least one processor is further configured to use the VS kernel module to add at least one of memory usage information and memory request performance information for different applications to messages sent from the server via the network interface for use by a network controller on the network in performing at least one of setting memory request rates and allocating memory for applications executed by servers on the network.

9. The server of claim 1, wherein the at least one processor is further configured to:
receive, from a network controller via the network interface, at least one of memory request rates and memory allocations for one or more applications executed by the at least one processor; and
adjust memory usage by the one or more applications based on the at least one of memory request rates and memory allocations received from the network controller.

10. A method performed by a server, the method comprising:
executing a Virtual Switching (VS) kernel module in a kernel space of at least one local memory of the server, the at least one local memory providing a shared memory,
wherein the server communicates with one or more network devices via a network and each network device of the one or more network devices provides a respective shared memory via the network;
receiving, by the VS kernel module, a packet from a Virtual Machine (VM) executed by the server or by a remote server;
parsing, by the kernel module, the packet to identify a memory request from an application executed by the VM;
using the kernel module to determine memory usage information for the application based at least in part on the identified memory request;
providing the determined memory usage information to a VS controller executed by the server; and
using the VS controller to adjust at least one of a memory request rate and a memory allocation for the application based at least in part on the determined memory usage information.

11. The method of claim 10, further comprising:
using the VS kernel module to further provide memory request performance information for different applications to the VS controller; and
using the VS controller to adjust at least one of memory request rates and memory allocations for the different applications executed by one or more VMs based at least in part on the memory request performance information.

12. The method of claim 10, further comprising:
retaining previous memory usage information for a previously executed application; and
in response to a new execution of the previously executed application, setting at least one of a new memory request rate and a new memory allocation for the previously executed application based on the retained previous memory usage information.

13. The method of claim 10, further comprising using the VS controller to adjust at least one of memory request rates and memory allocations for applications executed by local VMs running at the server and by remote VMs running at remote servers on the network.

14. The method of claim 10, further comprising using the VS kernel module to update a data structure in the kernel space for monitoring respective memory usage by different applications.

15. The method of claim 10, further comprising:
setting, by the VS controller, memory request rates and memory allocations for VMs accessing the shared memory provided by the at least one local memory;
providing the at least one of shared memory request rates and memory allocations set by the VS controller to the VS kernel module; and
sending an indication of at least one of a set shared memory request rate and a set memory allocation to at least one VM using the VS kernel module.

16. The method of claim 10, further comprising:
determining using the VS kernel module that a level of pending requests in at least one submission queue for the shared memory is greater than or equal to a threshold level of pending requests; and
in response to determining that the level of pending requests in the at least one submission queue is greater than or equal to the threshold level, setting a congestion notification in a message sent to a remote VM.

17. The method of claim 10, further comprising using the VS kernel module to add at least one of memory usage information and memory request performance information for different applications to messages sent from the server for use by a network controller on the network in performing at least one of setting memory request rates and allocating memory for applications executed by servers on the network.

18. The method of claim 10, further comprising:
receiving, from a network controller, at least one of memory request rates and memory allocations for one or more applications executed by the server; and
adjusting memory usage by the one or more applications based on the at least one of memory request rates and memory allocations received from the network controller.

19. A network controller, comprising:
a network interface configured to communicate with a plurality of servers on a network, wherein a plurality of network devices on the network provides a shared memory; and
means for:
retrieving memory usage information added to packets sent by the plurality of servers to network devices of the plurality of network devices, the memory usage information indicating usage of the shared memory by applications executed by Virtual Machines (VMs) running at the plurality of servers;
performing at least one of setting memory request rates and allocating memory for one or more applications executed by the VMs based at least in part on the retrieved memory usage information; and
sending the at least one of set memory request rates and memory allocations to at least one server of the plurality of servers to adjust usage of the shared memory by different applications executed by VMs running on the at least one server.

20. The network controller of claim 19, further comprising means for:
retrieving memory request performance information for different applications added to packets sent by the plurality of servers; and
using the retrieved memory request performance information to perform at least one of setting memory request rates and allocating memory for the one or more applications.
